(19) United States
(12) Patent Application Publication
(10) Pub. No.: US 2018/0132977 A1
(43) Pub. Date: May 17, 2018

(54) Insertion Kit For An Endosseous Single-Tooth Implant

(71) Applicant: Epiphanostics GmbH, Holzkirchen (DE)

(72) Inventor: Walter Dürr, Remchingen (DE)

(73) Assignee: Epiphanostics GmbH, Holzkirchen (DE)

(21) Appl. No.: 15/574,858

(22) PCT Filed: May 20, 2016
(86) PCT No.: PCT/EP2016/061503

§ 371 Date: Nov. 17, 2017

(30) Foreign Application Priority Data
May 21, 2015 (DE) 10 2015 108 098.2
Jun. 17, 2015 (EP) 15172612.2

(51) Int. Cl. A61C 8/00

(52) U.S. Cl. CPC A61C 8/0068; A61C 8/0087; A61C 8/0089; A61C 8/006

(57) ABSTRACT

An insertion kit for an endosseous single-tooth implant includes a main body, a screw-in base, a retaining screw, a screw-in head and a retaining shaft.

The invention relates to an insertion kit for an endosseous single-tooth implant with the features of claims 1 and 2 and developments thereof.

In a single-tooth implant, as it is known from DE 40 28 855 C2 and also as the object of DE 195 09 762.9-32, the locking against rotation occurs so that the main body positive-locking elements at the bottom of the annular recess of the main body and the spacer sleeve positive-locking elements, which are complementary thereto, are provided at the cervical front edge of the centering collar of the spacer sleeve. From the standpoint of manufacturing technology, such positive-locking elements can be produced only with relative difficulty, wherein, moreover, it is not particularly advantageous in some application cases that the full depth of the annular recess or of the centering collar is not available for the centering, fixing and securing of the spacer sleeve relative to the main body.

In another dental implant, as it is provided from DE 37 35 378, difficulties of similar type occur, due to the fact that here too the positive-locking elements of the main body are located at a distance from the coronal front edge thereof within a blind bore of the main body.

DE 41 27 839 A1 describes an implant main body, whose central annular recess has a positive-locking element, which directly adjoins the coronal front end of the main body, wherein the positive-locking element is designed in the form of a slot and the retaining part to be inserted in the main body has a complementary shape thereto. A separate implant post or retaining screw is not provided here.

DE 195 34 979 C1 describes a single-tooth implant, in which the positive-locking elements of the main body are arranged directly adjoining the coronal front end thereof with corresponding arrangement and design of the abutment positive-locking elements complementary thereto. Since the entire depth of the annular recess of the main body is available for the centering and guiding of the abutment, there should be a clearly improved stability of the connection between spacer sleeve and main body with greater design freedom in terms of the type of spacing and the shaping of the positive-locking elements.

In all such tooth implants, the implantation is carried out as a rule in such a manner that first the bone is uncovered, preferably only at the planned implant position, in order to be able to prepare the bone optimally for an implantation, and in the process a gingival flap (mucoperiostum or mucogingival) is often prepared. In the case of satisfactory bone conditions and sufficiently wide fixed gingival tissue, a tooth implant can even be set in a transgingival implantation without this uncovering of or unfolding of the gum tissue, by punching into the gum tissue. Using special drills, the implant bed is prepared, wherein a drilling template can be used in order to ensure the prosthetically optimal position and a precise drilling direction for the optimal position and alignment of the implant. The implant is then fitted precisely into the jawbone, wherein the so-called primary stability (initial mechanical stability) is one of the most important factors for the success of the osseointegration.

Here, in the setting of implants, a distinction is made between a one-phase modality with open healing and a two-phase modality with closed healing. The implant (main body) is set to the level indicated in the manufacturer instructions relative to the uncovered bone level. In the two-phase procedure, the prepared flap is sutured above the upper end of the main body, closed with a closure screw, for example. After the healing, the implant is uncovered in a second intervention to start the prosthetic treatment. In implantations that are connected with bone build-up measures, this two-step procedure provides protection against external influences.

In the one-phase procedure, implants heal “open.” This means that an implant after setting can protrude from the mucosa during the healing, and as a rule, it carries a temporary dental crown or a gingiva former. The implant head can then lie above the mucosa level, and an intervention for the uncovering of the implant is dispensed with.

The two procedures share the fact that the main body is introduced into the jaw bone of the patient usually by screwing into a bore introduced by the implantologist. After the osseointegration, in a next step, an abutment is inserted into the main body and fixed by means of a retaining screw to the main body. As a rule, a crown is fastened on the abutment. The phase of osseointegration often lasts up to several months, depending on the patient, and in the process it is important, for an interference-free growth, that the main body be introduced during the first step of the implantological measures as aseptically as possible at the implantation site and also kept aseptic during the implantation. For this purpose, particularly during the introduction of the main body into the jaw and before the closure of the main body, particular measures for asepsis are necessary, in order to ensure an interference-free osseointegration.

The aim of the invention it to improve the handling during the introduction of a tooth implant, and thus to provide an improved system for the introduction, and in so doing to consequently improve the osseointegration. Thus, the risk of infection can be decreased, the development of a pathological bacteria-caused disintegration can be prevented, and consequently the growth process can be supported, which, after the completion of the remodeling processes, can last for several months until the final strength of the implant in the jaw is achieved.

According to the invention, this aim is achieved with an insertion kit of the type mentioned at the start for an endosseous single-tooth implant by the combination of the features according to claims 1 and 2. Particular embodiments of the invention are the subject matter of the subsidiary claims and of the dependent claims.

Thus, the present invention relates to an insertion kit for an endosseous single-tooth implant for a fixed tooth replacement, with

a substantially cylindrical main body, which can be inserted into a bore introduced into a jaw bone, with an annular recess and with a bore arranged coaxially relative to the annular recess, and which comprises apically a threading for the securing of a retaining screw;

a screw-in base, which can be inserted into the annular recess of the main body, which comprises a bore, which penetrates through the screw-in base coaxially relative to the annular recess, for receiving a retaining screw;

a retaining screw with an apical outer threading and a coronal screw head, wherein the retaining screw can be inserted in the bore of the screw-in base and screwed into the threading of the main body;

a screw-in head, which can be engaged with the screw-in base, and which comprises a bore arranged coaxially relative to the annular recess, and

a retaining shaft, which can be inserted in the bore of the screw-in head and which, at one end, can be fixed to the retaining screw and, at the other end, comprises a placement for a dental angle piece.

When using the insertion kit according to the invention, in a two-phase healing, it is possible to proceed in such a way that, in the first surgical phase, after setting the implant, the screw-in head and the retaining shaft are removed, and the screw-in base is closed with a closure screw which is, for example, injection molded. Subsequently, the insertion area is closed by means of a mucosa-periosteum flap/mucogingival flap. In the second surgical phase, the mucosa over the implant is opened, and the screw-in head can be screwed in. The geometry of the screw-in head with lateral surfaces is also suitable as scanbody.

Depending on the indication, the screw-in head can also be separated beneath the tool placement, and, for example, a temporary crown or a bite cap for marking the implant position in a bite plate can be attached. Alternatively, after the screwing in of the screw-in head, an impression cap can be put on, so that a closed tray impression can be obtained. For the open tray impression, an impression post can be screwed in.

The main body-introduction base/body connection is in any case opened only after a sufficient implant/bone connection as well as an epithelial attachment and a subepithelial connective tissue attachment have formed.

The insertion kit according to the invention is characterized in that it enables a separation between indexing (positioning) and force transmission elements for screwing in the main body, which is not provided in this manner in the prior art, and it enables a direct force transmission from the angle piece head to the screw-in head/screw-in body (single-piece/two-piece) and from there to the force transmission elements onto the main body, and that indexing elements, for example, in the form of spring webs, do not to come in contact with the force transmission elements on the main body, and thus the utmost precision is guaranteed for the later introduction of the abutment. In the process, the screw-in head/screw-in body (single-piece/two-piece) can also be used as temporary abutment, and an exact impression (3D position) is possible by means of an intra-oral scanner, and therewith further processing of the data with CAD/CAM technology.

The present invention also relates to the sub-combination of the insertion kit according to the invention, consisting of

the substantially cylindrical main body, which can be inserted into a bore introduced into a jaw bone, with an annular recess, and with a bore which is arranged coaxially relative to the annular recess, and which comprises apically a threading for the securing of a retaining screw;

the screw-in base, which can be inserted into the annular recess of the main body, and which comprises a bore penetrating through the screw-in base coaxially relative to the annular recess, for receiving a retaining screw; and

the retaining screw with an apical outer threading and a coronal screw head, wherein the retaining screw can be inserted into the bore of the screw-in base and screwed into the threading of the main body.

The annular recess of the main body can include an apical guide section, a positive-locking section and a coronal end section, wherein the screw-in base comprises an apical guide section, a positive-locking section and a coronal end section, which correspond in a shape-complementary manner to the sections of the main body.

The present invention further relates to the endosseous single-tooth implant prepared with the insertion kit according to the invention and consisting of main body and abutment, as well as the components, main body and abutment, used in the single-tooth implant.

Advantageously, the positive-locking section of the main body and the positive-locking section of the screw-in base have mutually shape-complementary screw-in elements, which are made to engage in one another during the insertion of the screw-in base into the main body, wherein, in engagement position of the mutually shape-complementary screw-in elements, the screw-in base and the main body are secured in a rotationally fixed manner with respect to one another. When, according to the invention, screw-in elements are referred to as positive-locking elements, the said screw-in elements can also bring about a frictional locking or a positive-locking and frictional locking connection, depending on the design of the elements. For the sake of simplicity, the term positive locking is used in the context of the invention.

In addition, at the coronal end, the screw-in base can have a positive-locking section with screw-in elements, which can be made to engage together with screw-in elements of the screw-in head, wherein, in engagement position of the mutually shape-complementary screw-in elements, the screw-in base and the screw-in head are secured in a rotationally fixed manner to one another.

In an embodiment of the insertion kit according to the invention for an endosseous single-tooth implant, the screw-in base and the screw-in head can also be designed to form a single piece referred to jointly as screw-in body. An insertion kit according to the invention with such a single-piece screw-in body can advantageously be used for one-phase healing. This enables an undisturbed formation of the bone-implant bond, of the subepithelial connective tissue attachment and of the epithelial attachment. The sterile introduction of the inner configuration ensures sterility during the healing process. A shortening of the screw-in body or of the screw-in head beneath the coronal end, for example, at a circumferential annular slot, and a closing of the bore in the screw-in head/screw-in body with a gingival cap are possible here, so that an adaptation to the respective jaw conditions or the requisites of the implantologists is possible.

In a two-piece design of screw-in base and screw-in head, for the fixation of the screw-in base and of the main body to one another, or in a single-piece design of screw-in base and screw-in head, jointly referred to as screw-in body, for the fixation of this screw-in body and of the main body to one another, according to the invention, a retaining screw with an apical outer threading and a coronal screw head is provided, wherein the retaining screw can be inserted into the bore of the screw-in base or of the screw-in body and screwed with the apical outer threading into the apical threading of the main body. Here, the retaining screw with the apical end of the screw head, which can be designed to be annular or conical, can come in contact on the annular or conical inner margin of the bore of the screw-in base or of the screw-in body and secure them in a rotationally fixed manner.

For the fixation of the retaining shaft or of an additional retaining screw, which can be arranged for the fixation of the screw-in head on the screw-in base, the screw head of the retaining screw by means of which the screw-in base or the screw-in body can be fixed with respect to the main body, can have an inner polygon and preferably an inner threading arranged in the inner polygon, into which threading the retaining shaft or the additional retaining screw can be screwed.

In order to form, in a two-piece design of a screw-in base and screw-in head, a flat front surface for the placement of the screw-in head, the screw head of the retaining screw, in the use position, can be sunken in the screw-in base. Here, between screw head and screw-in base, an annular slot can be formed, which can receive a section of the screw-in head for centering and guiding.

According to the invention, depending on the design of screw-in base and screw-in head, the retaining screw and the retaining shaft can be designed in the form of a single piece. In the same way, the retaining shaft can be designed in the form of two pieces, particularly in the form of the additional or other retaining screw, which can be arranged on the screw-in base for the fixation of the screw-in head, and of a shortened retaining shaft, which can be particularly advantageous in the case of vertically constricted jaw conditions.

In the use of the insertion kit according to the invention for an endosseous single-tooth implant for a fixed tooth replacement, the retaining shaft is advantageously designed so that, in use position, it retains in engagement main body, screw-in base and screw-in head, single-piece or two-piece, particularly the mutually corresponding screw-in elements.

According to the invention, in each case in pairs, as mutually corresponding screw-in elements, shape-complementary inner edge-outer edge pairs, also referred to according to the invention as inner edge surface-outer edge surface or inner surface-outer surface, are formed coronally on main body and apically on screw-in base—or screw-in body—, as well as coronally on screw-in base and apically on screw-in head, which in the manner of a triangle, square, pentagon or hexagon, or polygon, enable the positive/frictional locking and thus ensure the transmission of the torque from the—manually driven or motor driven—tool onto the main body. Alternatively, the mutually corresponding screw-in elements can also be designed as shape-complementary pairs of pins and recesses or as shape-complementary pairs of Morse taper and Morse cone, wherein different shape-complementary screw-in element pairs can also be used in the insertion kit according to the invention. Thus, inner edge-outer edge pairs can be provided coronally on main body and apically on screw-in base, and a Morse taper-Morse cone pair can be provided coronally on screw-in base and apically on screw-in head.

The screw-in elements can in each case be designed in the form of two or more, preferably three “coaxial” planar surfaces arranged evenly spaced circumferentially (inner polygon) in the annular recess on the main body and in the form of two or more, preferably three “coaxial” planar surfaces arranged evenly spaced circumferentially (outer polygon as head with two, three, four or more sides) on the screw-in base.

Between any two screw-in elements, such as the inner edge surfaces or pins (as positive-locking and/or frictional locking elements), in each case circumferentially a transition area can be provided, which can be designed in the form of a radially inward directed web or protrusion (in the center area). Here, such a web/protrusion can have a radially inward directed section, which can also be designed as a surface, with web side surfaces, which are adjacent on both sides to the screw-in elements, or which transition into them. A screw-in element formed as outer edge surface can be formed so that the planar surface of the outer edge surface is provided, at least in screw-in direction, preferably in both rotation directions, with a lateral protrusion, which, when the main body is screwed into the jaw, comes in contact with the corresponding web side surface, but not with the web tip, and which, in addition, supports the transmission of the torque from the screw-in tool to the main body and at the same time reduces the tolerance-caused play between the screw-in elements and at the same time functions as stop. Here, in particular in the case of webs on the main body, contact with the tip/center area of the web should be avoided, in order to prevent damaging the tip/center area of the web. The position of the webs, which can be arranged radially directed inward in the bore of the main body, or of the corresponding recesses for the webs in the corresponding component, can be made visible from outside via one or more markings on the main body, the screw-in base, the screw-in head and/or the screw-in body. As such markings, scanbody markings such as surfaces of the scanbodies, enabling the digital acquisition of the implants or laboratory implant position relative to the rest of the dentition and the soft tissue, can also be used.

A single-tooth implant, which, using the inventive insertion kit for screwing in the main body and after subsequent insertion of an abutment, can be arranged in the jaw bone, thus comprises a main body, an abutment, which can be inserted in the main body, as well as a retaining screw, which penetrates through the main body and the abutment, and which fixes the position of the abutment with respect to the main body and can be screwed into a threading section provided at the apical end of the main body.

As described, the main body has an annular recess into which the abutment can be inserted after the main body has healed in the jaw and the retaining screw and the screw-in base have been removed. The annular recess can here comprise a guide section at the apical end of the annular recess, a positive-locking section and a coronal end section, to which the corresponding sections of the abutment—and of the screw-in base—are complementarily matched. The coronal end section in the main body is preferably designed to be cylindrical, to which the corresponding section in the abutment is matched. In the positive-locking sections, positive-locking elements, which are different from the screw-in elements, such as webs and slots are arranged, preventing the relative movement of abutment and main body in circumferential direction. Here, the design of the main body with axial webs, which engage with axial slots on the abutment, is preferable.

The guide sections on main body and abutment are in each case designed with respect to one another in the manner of a fit with play. Thus, a reliable guiding of the screw-in base or abutment in the main body is made possible. Here, for the case in which guide section and positive-locking section are designed as two distinct sections, during the sliding in of the screw-in base or abutment, the respective guide sections can engage on main body/screw-in base or on main body/abutment, before the positive-locking section is made to engage.

In such a fit with play, the maximum radial size of the guide section of the screw-in base or abutment is smaller than the minimum radial size of the guide section of the main body. Here, the tolerance ranges are selected so that the play, that is to say the maximum radial distance between minimum size of the guide section of the screw-in base or abutment and maximum size of the guide section of the main body receives an acceptable value or slide-in resistance and guiding.

After the main body has been screwed into the jaw and the screw-in base or the screw-in body has been removed, an abutment can be inserted into the main body in a manner so it can be oriented circumferentially, wherein positive-locking elements such as spring webs on main body and slots on abutment can be made to engage with one another, and in the process main body and abutment can be secured in a rotationally fixed manner to one another. Subsequently, main body and abutment are fixed into the position in which they are secured to one another via a retaining screw.

The positive-locking section of the main body and the positive-locking section of the abutment are adapted to one another in terms of shape in such a manner that the abutment can be inserted into the recess of the main body so that the respective webs and slots can be made to engage with one another, thus preventing a movement in circumferential direction. The respective positive-locking sections can be designed as hollow cylindrical areas of the annular recess, also with sections having different diameters, in the main body and the respective outer cylindrical section or sections of the abutment corresponding thereto.

The design of the endosseous single-tooth implant according to the invention allows the use of different materials or material combinations, which can be selected from the group of the metals, the metallic alloys, ceramic materials and combinations thereof.

Here, the main body can preferably be selected from a material consisting of the group of the metals, the metallic alloys, ceramic materials and combinations thereof. Preferably, the implant material used and the insertion kit overall consist of metallic materials such as pure titanium or metallic titanium alloys, chromium/nickel/aluminum/vanadium/cobalt alloys (for example, TiAlV4, TiAlFe2,5), high-grade steels (for example, V2A, V4A, chromium-nickel 316L), ceramic materials such as hydroxyl apatite, aluminum oxide, zirconium oxide or of a combination thereof in which the metallic material is in the form of a composite material with ceramic material.

The following detailed description of the elements of the invention is applicable in this respect in each case to all the embodiments of the invention, unless otherwise indicated.

According to the invention, the guide section, which is provided apically relative to the positive-locking section and preferably designed to be cylindrical, allows a reliable and stable fixation of the screw-in base or later of the abutment in the main body by means of the retaining screw, since the respective components are mounted via guide section with fit with play in the manner of a pipe-in-pipe mounting. The radial inner diameter of guide section in the main body and the outer diameter in the abutment are selected in such a manner that the wall thickness in the main body is sufficient to prevent deformations of the main body walls in the case of lateral or angular loading of the implant during the chewing process.

According to the invention, the mutually complementary positive-locking elements on main body and screw-in base in each case are designed in the form of a male part-female part connection, wherein the male part(s) is/are preferably arranged on the main body. Due to the arrangement thus selected, as a result of the avoidance of a decrease in the wall thickness of the main body, precise force transmission is possible even with ceramic materials, which makes it possible to use completely ceramic or partially ceramic main bodies, in addition to the known metals and alloyed materials.

According to the invention, the male positive-locking element in each case can be in the form of a spring web extending parallel to the longitudinal axis of the main body and engaging in each case in a corresponding female part on the other component, preferably a slot, in a rotationally fixed manner. The positive-locking elements can be carved out by mechanical processing such as machining, drilling, etc. from the components main body and abutment.

The positive-locking section can be designed cylindrically. In a cylindrical design, the positive-locking section on the screw-in base or abutment is designed in the form of a cylindrical section with the outer diameter thereof, which is matched to the hollow cylindrical bore on the main body in terms of the length and the diameter.

According to the invention, the spring web can advantageously be designed in the form of a machined nose, web or of a pin held in each case in a blind bore (retaining bore). The pin can preferably have a circular, or regular or irregular polygonal cross section, of which a cross-sectional segment protrudes from the slot in the conical wall radially relative to the direction of the longitudinal center axis, depending on the relative position of male part and female part, of the main body, and can form the spring web as far as over the maximum axial length of the positive-locking section. In the simplest form, a pin can have a cylindrical shape and be produced, for example, in a wire drawing machine.

For the implant post/retaining screw, an inner threading is provided in the blind bore apically of the conical positive-locking and centering section of the main body, wherein the retaining screw also completely passes through the abutment.

Another aspect of the present invention is that—in addition to a simplified mechanical machining of the components and the simplified handling—the conditions during the single-phase or two-phase implantation can be kept as aseptic as possible in the main body, particularly in the healing phase, and thus a balanced mechanical stability can also be achieved during the introduction of the implant in the jaw and the use thereof during the chewing process, which is not the case in the systems known in the prior art.

For the preparation of the insertion kit according to the invention, the screw-in base or the screw-in body can be inserted into the annular recess of the main body, and, in the process, the shape-complementary screw-in elements of main body and screw-in base (apical) or screw-in body are made to engage with one another. By means of the (apical) retaining screw, the screw-in base can be fixed in the main body.

In the two-part form of screw-in base and screw-in head, the screw-in head is put on the screw-in base, and the shape-complementary screw-in elements on screw-on base (coronally)/screw-in head in the respective positive-locking section are made to engage with one another. The screw-in head can then be secured in a rotationally fixed manner by means of the retaining shaft or by means of a second retaining screw and retaining shaft on the first (apical) retaining screw.

In the case of the single-piece form of screw-in base and screw-in head, the screw-in body is put on the main body and in the process the shape-complementary screw-in elements on main body and screw-in body in the respective positive-locking section are made to engage with one another. The screw-in body can then be secured in a rotationally fixed manner via the (apical) retaining screw and retaining shaft or, depending on the design, via a second retaining screw and retaining shaft on the first retaining screw.

After the securing of the retaining shaft, in the case of the single-piece or two-piece form of screw-in base and screw-in head, the insertion kit according to the invention can be sterilized, advantageously by -sterilization, and stored in a sterile packaging for use.

For use, the implantologist removes the insertion kit from the sterile packaging and puts a polygonal socket on the retaining shaft, which encloses the polygon at the coronal end of screw-in head or screw-in body, and then puts the retaining shaft (with polygonal socket) into the screw-in tool in such a manner that the securing element present on the coronal end of the holding shaft, like a circumferential annular slot, can engage in a holder on the screw-in tool, and at the same time the polygonal socket can engage in the force transmission component on the screw-in tool. In the process, taking into consideration the conditions in the jaw of the patient, the implantologist can select a one-phase or a two-phase implantation method and accordingly determine the type of the insertion kit with one-piece screw-in body or with two-piece variant with screw-in base and screw-in head. In each case, it is ensured that the implantologist can introduce a closed sterile system of main body and screw-in base/screw-in body into the jaw of the patient, and thus create optimal conditions for growing the implant into the jaw.

Below, embodiment examples of the insertion kit according to the invention and the components thereof are explained in detail in reference to the diagrammatic drawings. In the drawings:

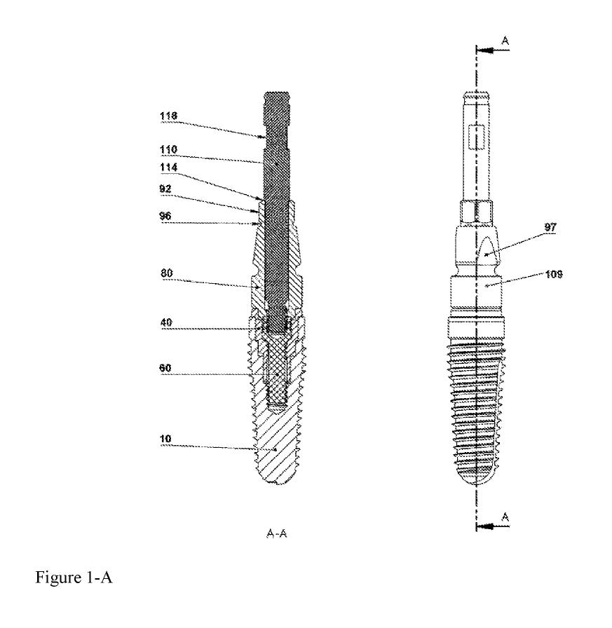

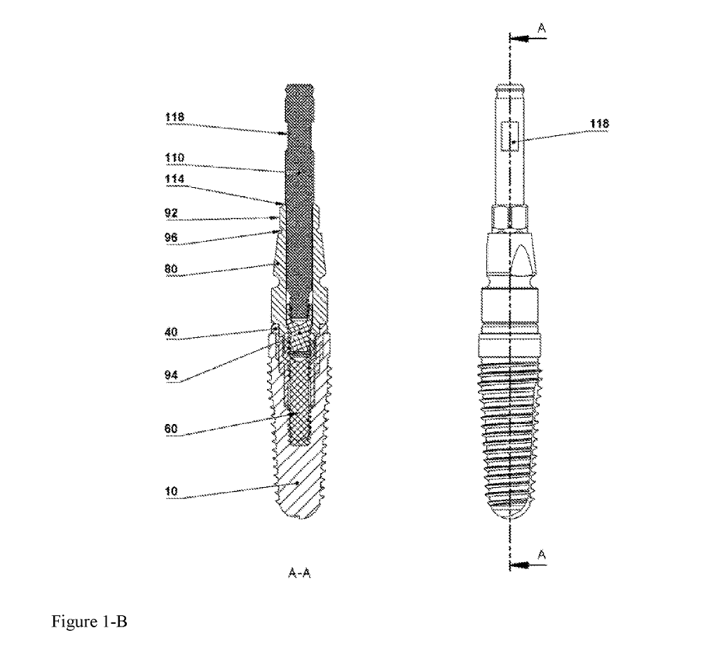

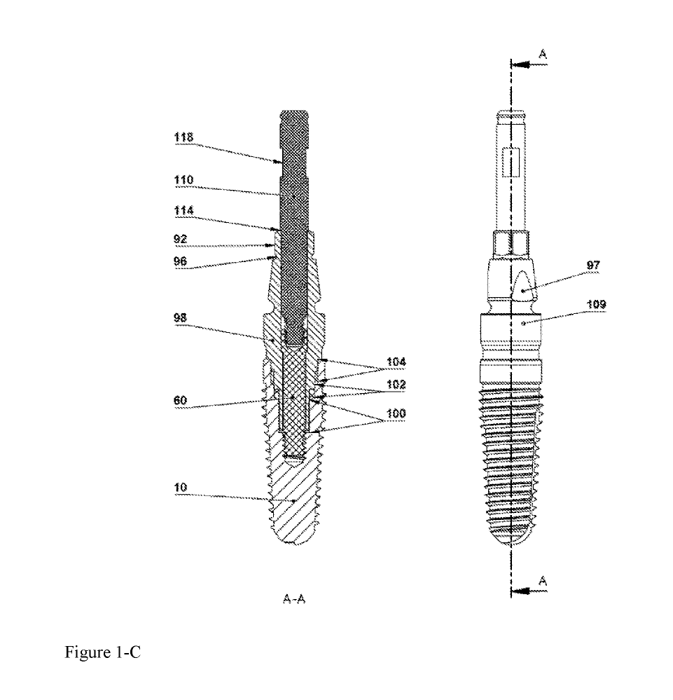

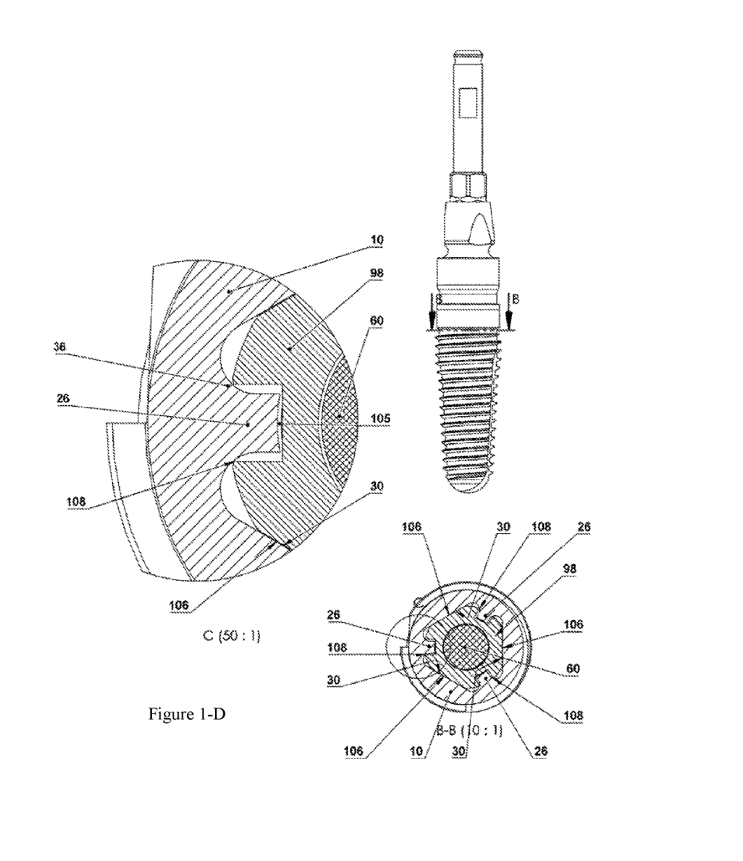

FIG. 1A shows an embodiment example of an insertion kit according to the invention in the axial longitudinal section along the plane shown in the top view on the right; this embodiment is suitable primarily for covered healing;

FIG. 1B shows another embodiment example of an insertion kit according to the invention in the axial longitudinal section along the plane shown in the top view on the right; this embodiment allows both covered healing and also transgingival healing;

FIG. 1C shows another embodiment example of an insertion kit according to the invention in the axial longitudinal section along the plane shown in the top view on the right; this embodiment is suitable mainly for transgingival healing;

FIG. 1D shows a cross-sectional view of the embodiment example from FIG. 1C at the level of the main body-screw-in body connection in the plane B-B shown in the top view on the right, as well as a detail view thereof;

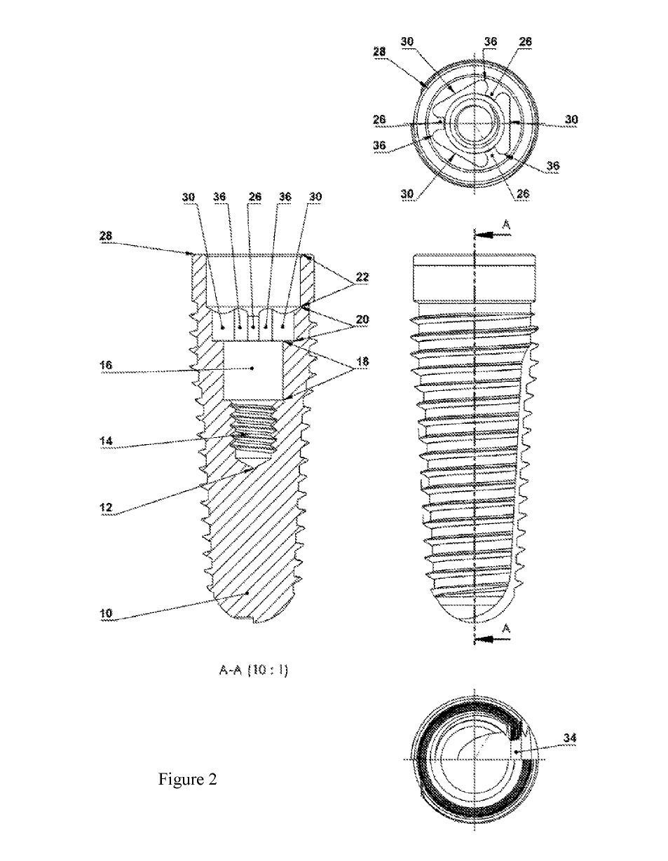

FIG. 2 shows an embodiment example of an implant main body used in the insertion kit according to the invention as shown in FIG. 1A, 1B or 1C, in the axial longitudinal section along the plane shown in the top view on the right, as well as respectively a top view from below and from above onto the main body;

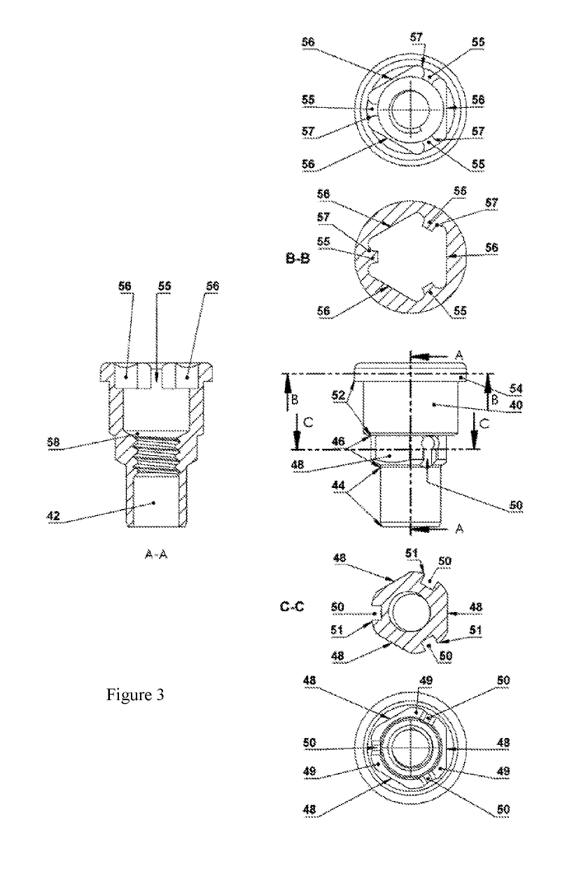

FIG. 3 shows an embodiment example of a screw-in base used in the insertion kit according to the invention and as shown in FIG. 1A or 1B, in the axial longitudinal section along the plane shown in the top view on the right, as well as respectively a top view from below and from above onto the screw-in base and respectively a cross-sectional view in the planes B-B and C-C shown in the top view on the right;

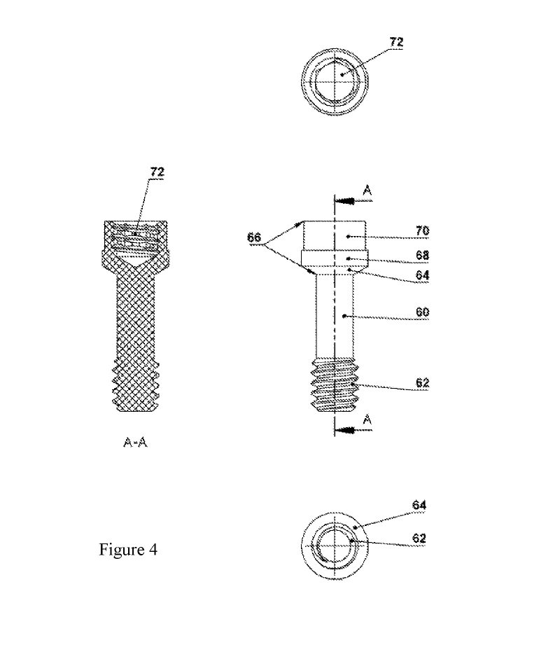

FIG. 4 shows an embodiment example of a retaining screw used in the insertion kit according to the invention as shown in FIG. 1A and 1B—for the securing of the screw-in base in the main body—in the axial longitudinal section along the plane shown in the top view on the right, as well as respectively a top view from below and from above onto the retaining screw;

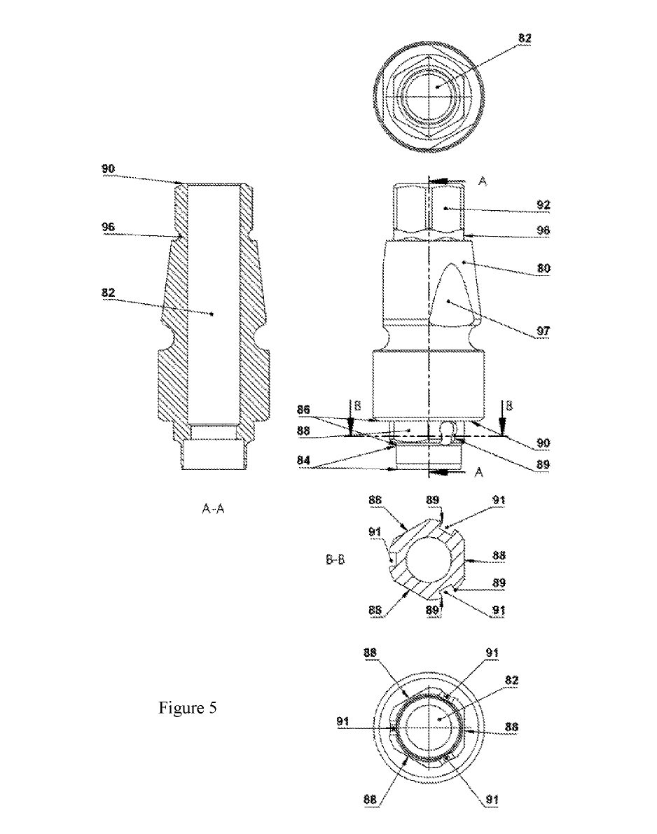

FIG. 5 shows an embodiment example of a screw-in head used in the insertion kit according to the invention as shown in FIG. 1A and 1B, in the axial longitudinal section along the plane shown in the top view on the right, as well as respectively a top view from below and from above onto the screw-in head and a cross-sectional view in the plane B-B shown in the top view on the right;

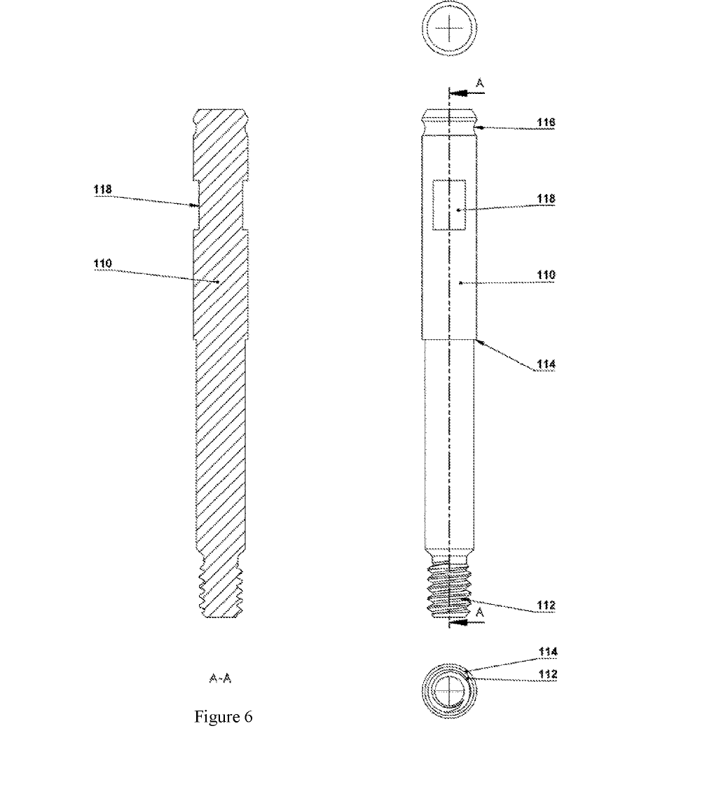

FIG. 6 shows an embodiment example of a retaining shaft used in the insertion kit according to the invention as shown in FIG. 1 in the top view, as well as respectively a top view from below and from above onto the retaining shaft;

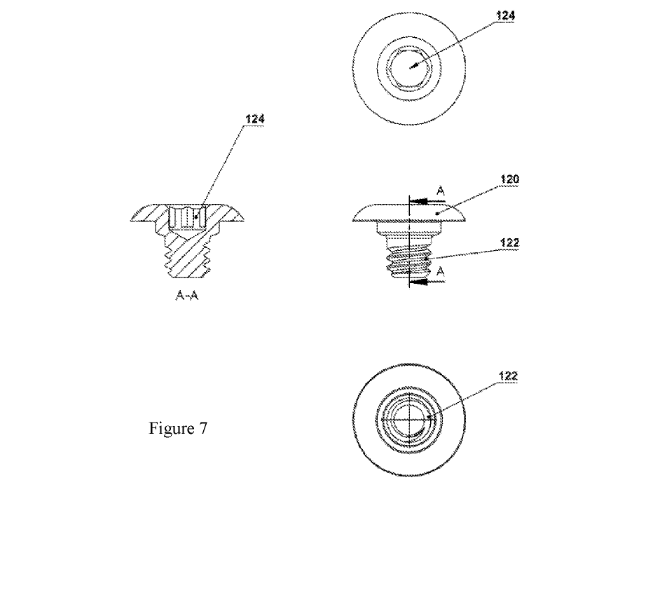

FIG. 7 shows an embodiment example of a closure screw for closing the screw-in base and the retaining screw in the axial longitudinal section along the plane shown in the top view on the right, as well as a top view from below and from above onto the closure screw;

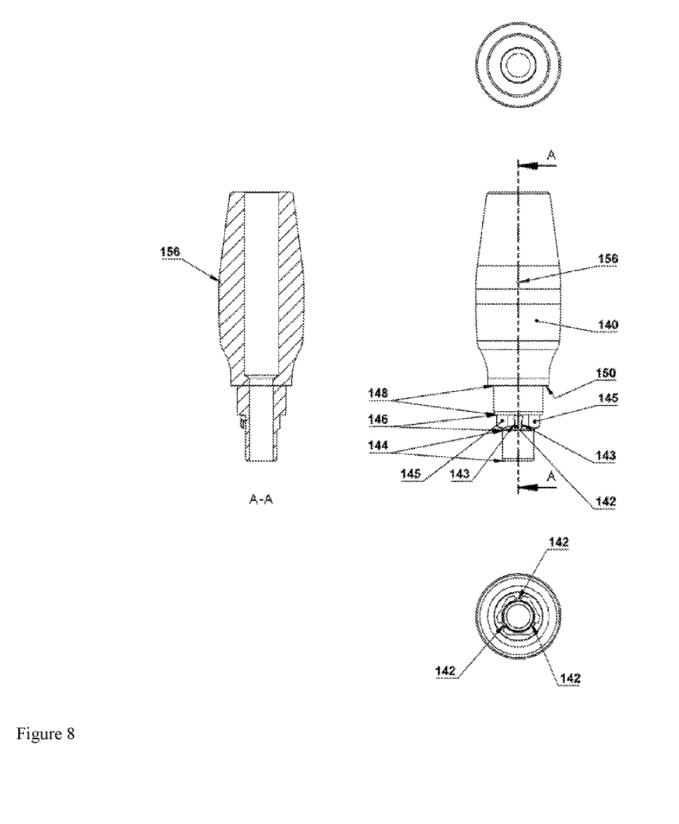

FIG. 8 shows an embodiment example of an abutment, which can be used with the main body according to the insertion kit according to the invention as shown in FIG. 2, in the axial longitudinal section along the plane shown in the top view on the right, as well as a top view from above onto the abutment;

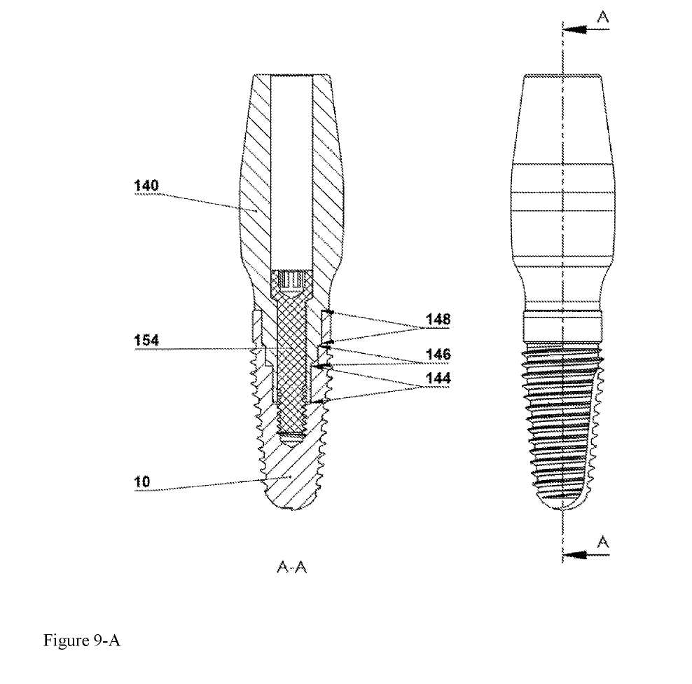

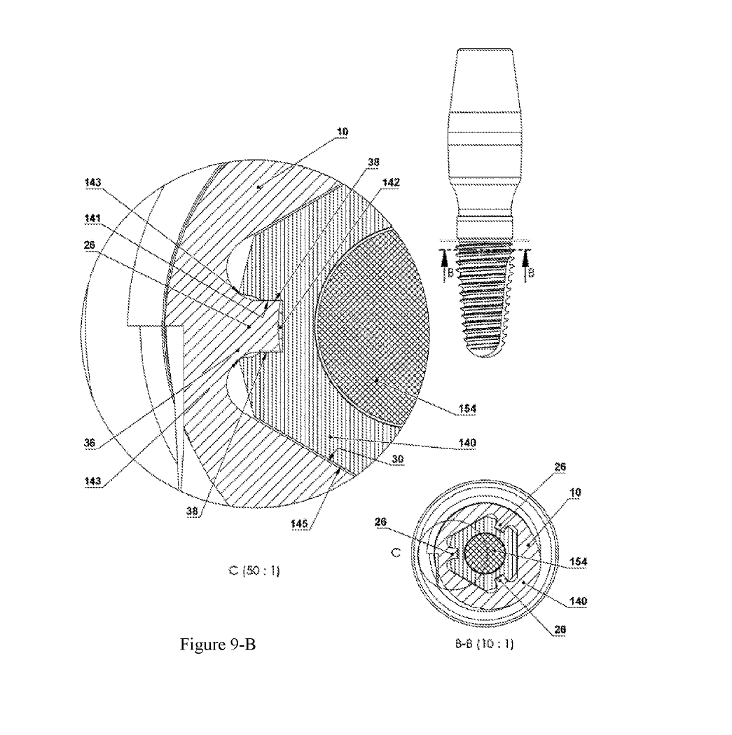

FIG. 9A shows an embodiment example of a main body as used in the insertion kit according to the invention as in FIG. 1, with an abutment inserted into the main body and secured by a retaining screw in the top view as well as in the axial longitudinal section along the plane A-A in the top view;

FIG. 9B shows a cross-sectional view of the embodiment from FIG. 9A at the level of the main body-abutment connection in the plane B-B shown in the top view on the right, as well as a detail view thereof.

As diagrammatically shown in the longitudinal section in FIG. 1A, in a design, the insertion kit according to the invention comprises the main body 10, the screw-in base 40 with retaining screw 60 secured therein, the screw-in head 80 sitting on the screw-in base as well as the, here single-piece, retaining shaft 110, which penetrates into the screw-in head 80, and which is secured in the retaining screw 60 in the screw-in base 40.

In the embodiment of the insertion kit according to the invention shown in FIG. 1A, via the retaining shaft 110 and the tool not represented in the drawing, for example, a polygonal socket, which is stuck onto the retaining shaft 110 and encloses the outer polygon 92 with positive locking, the torque is transmitted from the dental angle piece to the main body. For this purpose, the retaining shaft 110 is provided at the apical end thereof with a threading, which can be screwed into the retaining screw 60, or which can be secured there by means of a bayonet closure. The retaining shaft 110 is formed, for example, in such a manner that, by means of a possibly conical collar flange 114, which is provided in the middle section of the retaining shaft 110, and which lies coronally on the end section of the screw-in head 80 with the outer polygon 92, the screw-in head 80 is retained against the screw-in base 40 and, with the screw-base 40, it forms apically in the area of the front surface 90 a positive-locking and/or frictional locking connection. The screw-in base 40, in its turn, is secured in the main body 10 via the retaining screw 60, and secured against circumferential twisting by the screw-in elements arranged in the positive-locking area of the main body-screw-in base pair. The position of a screw-in element can be indicated via the index marking 109. The individual components of the insertion kit according to the invention are described in further detail below.

The insertion kit according to the invention allows the implantologist to screw the insertion kit, which has been removed from the packaging and fixed to the dental angle piece, into the bore in the jaw of the patient and, depending on conditions at the implantation site, to start the preparations for the one-phase or two-phase healing. For this purpose, by means of the dental angle piece, a torque is transmitted via the retaining shaft 110 and the polygon 92 onto the main body and enables a simple screwing of the main body into the jaw, without the need for other assemblies for this purpose. After the end of the process of screwing the main body into the jaw, the retaining shaft 110 can, if necessary, be unscrewed from the threading of the retaining screw 60. For this purpose, on the retaining shaft, a placement 118 for tools such as an open-end wrench can be provided. The screw-in head 80 can be fixed via jamming or screw elements on the screw-in base 40 or via an additional retaining screw 94, as shown in FIG. 1B, on the retaining screw 60 and, depending on the decision of the implantologist, can be removed from the screw-in base for the one-phase or two-phase healing.

If the implantologist decides to use one-phase healing, the screw-in head 80 can remain on the screw-in base 40, and can itself be used as retainer for a temporary tooth replacement, as a kind of temporary abutment, or as a scanbody. Here, for the use as temporary abutment, the polygon 92, for example, a hexagon, arranged at the coronal end of the screw-in head, can be detached at the annular slot 96 under the polygon 92 after the removal of the retaining shaft 110, and the remaining lower portion of the screw-in head 80 can be used for the fixation of such a temporary tooth replacement. The screw-in head 80 can advantageously form a positive-locking and/or frictional locking connection with the screw-in base 40. Here, this positive-locking connection can also be designed so that the screw-in head 80 is stuck via the positive-locking elements on the screw-in base 40 or can be fixed via the additional retaining screw 94.

As explained, the screw-in base 40 can be fixed in the main body via the retaining screw 60. Here, the retaining screw is provided with an apical threading 62, a middle section and a screw head 66. In the screw head 66, a fixation for the retaining shaft 110 or for a second retaining screw 94 in the manner of an inner threading can be provided, into which the retaining screw 110 can be screwed via the threading 112 provided in the apical end thereof or via the second retaining screw 94 as shown in FIG. 1B. The retaining screw 94 enables the use of a shorter retaining shaft 110 if the jaw conditions require this. Alternatively to a threaded connection between the retaining screw 60 and the retaining shaft 110, a snap-in connection—not represented—in the manner of a bayonet connection can be provided, which engages in the screw head when the retaining shaft 110 is introduced, and which fixes the retaining shaft 110 via the retaining screw 60 on the screw-in base 40. A positive-locking connection—not represented—between retaining shaft 110 and screw-in head 80 can also be implemented via a polygon connection, in which the bore in the screw-in head, at least in a section, is implemented in the manner of an inner polygon, to which a corresponding section of the retaining shaft 110 is matched in the manner of an outer polygon. The outer polygonal section of the retaining shaft, for example, in the shape of a hexagon, can extend nearly to the apical end of the retaining shaft, wherein, at the apical end of the retaining shaft, an annular slot is provided, in which an O-ring can be mounted, which engages in a corresponding annular slot in the screw head 66 of the retaining screw 60 and thus can form a snap-in connection.

FIGS. 1B and 1C show other embodiments of an insertion kit according to the invention. Here, FIG. 1B, as also shown diagrammatically in the longitudinal cross section in FIG. 1A, shows the insertion kit according to the invention in a design with main body 10, the screw-in base 40 with retaining screw 60 secured therein, the screw-in head 80 sitting on the screw-in base with second retaining screw 94 secured therein, as well as the single-piece retaining shaft 110, which penetrates through the screw-in head 80 and is secured in the retaining screw 94 in the screw-in base 40.

FIG. 1C diagrammatically shows, similarly to FIG. 1A, in the longitudinal section, another embodiment of the insertion kit according to the invention in a design with main body 10 and with a single-piece screw-in body 98 (consisting of screw-in base 40 and screw-in head 80) with retaining screw 60 secured therein as well as the single-piece retaining shaft 110, which penetrates through the screw-in body 98 and is secured in the retaining screw 60. In a variant of this embodiment, which is not represented, the retaining shaft 110 can also be secured in a second retaining screw 94. As shown in the detail drawing for FIG. 1C and the enlarged representation thereof according to FIG. 1D, the screw-in elements (30; 106) on main body 10 and screw-in body 98 are designed so that the torque transmission from the screw-in body 98 to the main body 10—and correspondingly also in the case of torque transmission from the screw-in base 40 to the main body 10, or from the screw-in head 80 to the screw-in base 40, as explained below—is made possible without contact between the spring webs (26, 55) and slots (50, 91). For this purpose, the spring webs (26, 55) and slots (50, 91) in each case are designed with sufficient play with respect to one another, so that, during the rotation, no contact is made between web (26, 55) and slot (50, 91), and thus the webs (26, 55) and slots (50, 91) are protected against mechanical damage. This can be supported furthermore in that the slot edges of the slots and the webs and the lateral surfaces thereof are designed so that, particularly during the screw-in movement, the slot edges which are coaxial relative to the longitudinal axis of main body are braced against the web side surfaces 38 in the area of the web root 36, and contact between the radial end of the spring web and the slot is avoided, and, in particular, shearing off of the spring web is prevented in the manner of an impact protection, is prevented.

In principle, when using a second retaining screw 94, it is advantageous if the head of this retaining screw 94 ends beneath the plane of annular slot 96, so that a detachment of the polygon 92 without impediment by this second retaining screw 94 is possible.

FIG. 1D shows a cross-sectional view of the embodiment example from FIG. 1C at the level of the main body-screw-in body connection in the plane B-B shown in the top view on the right, as well as an enlarged detail view thereof. The screw-in element pairs—in the preferred embodiment three screw-in element pairs—are here designed in the form of inner edge surfaces 30 on the main body 10, which come in contact with the outer edge surfaces 106 on the screw-in body 98 and allow the transmission of the torque from the screw-in tool to the main body 10. Here, between every two screw-in element pairs (30, 106), a positive-locking element pair (26, 105) in the form of a spring web-slot connection is arranged, wherein the slot edges 108 lie on the spring web root 36 of the spring web 26 on the main body, and, between the bilateral contact points, there is no contact between slot and spring web, in order to prevent damaging the web particularly when screwing in the main body. This detail representation according to FIG. 1D in principle also applies to the screw-in element pairs between main body and screw-in base or between screw-in base and screw-in head, wherein, in the latter case, contact between web surfaces and slot surfaces is also permissible.

For reasons pertaining to manufacturing and also to reusability, in all the components with screw-in element pairs of the insertion kit according to the invention in the form of a spring web-slot connection (26, 50; 26, 105; 55, 91) between two adjacent screw-in element pairs (30, 48; 56, 88; 30, 106), the positive-locking element pair is preferably arranged in the positive-locking section in such a manner that, when the main body is screwed in or unscrewed from the jaw, there is no contact between the spring web and slot, and only the slot edge (51; 89; 108), which is coaxial relative to the longitudinal axis of the main body, of at least one slot (50; 91; 105), comes in contact, in rotation direction, with the spring web root (36; 57), which is coaxial relative to the longitudinal axis of the main body (10), of the corresponding spring web (26; 55).

Here, the positive-locking element pair in the form of a spring web-slot connection (26, 50; 26, 105; 55, 91) between two adjacent screw-in element pairs (30, 48; 56, 88; 30, 106) is preferably arranged in such a way that the slot edge (51; 89; 108), which is coaxial relative to the longitudinal axis of the main body, comes in contact on both sides with the spring web root (36; 57), which is coaxial relative to the longitudinal axis of the main body (10), of the corresponding spring web (26; 55), wherein, between the two contact points, spring web and slot are spaced apart with play.

As shown in FIG. 2, the main body, 10 at its apical end shown at the bottom in FIG. 1, is designed closed and has a blind bore 12, which is open toward its coronal end located at the top in FIG. 1, with an inner thread 14 at the apical end of the blind bore 12. A retaining screw 60, not shown in the drawing in FIG. 2, for the screw-in base 40 or an abutment 140 can be screwed into the inner threading. In coronal direction, a hollow cylindrical annular recess 16 having a greater inner diameter than the inner threading 14 adjoins the inner threading 14 of the main body 10. In the form represented, the annular recess 16 has three areas 18; 20; 22. Thus, the annular recess 16 according to FIG. 2 comprises a guide section 18, which coronally adjoins the inner threading 14. In coronal direction, a positive-locking section 20 adjoins the guide section 18 of the annular recess 16, positive-locking section, which has a greater inner diameter than the guide section 18 and which, at least in sections, can comprise a conical inner wall with—in the embodiment according to FIG. 2—three radially inward directed spring webs 26. The spring webs 26 are formed so that they correspond, in the manner of a tongue and groove connection, to the slots 142 on the abutment 140 shown in FIG. 8, and they can preferably have dimensions such that they extend over the entire axial length of the positive-locking section 20. The spring webs 26 can be formed by machine-operated mechanical or electrochemical processing from the main body.

According to FIG. 2, in the positive-locking section 20, in each case an inner edge surface 30 as screw-in element is preferably provided between every two spring webs 26, inner edge surface with which in each case a corresponding, shape-complementary outer edge surface 48 on the screw-in base 40, shown in FIG. 3, as screw-in element can come in contact during the process of screwing the main body 10 into the jaw. In addition, a screw-in element formed as outer polygonal surface can in each case be formed on the screw-in base or on the screw-in body, in such a way that the planar surface of the outer edge surface, which can also be formed so that it projects radially, can come in contact, at least in screw-in direction, by means of a slot edge 51/108, during the screwing in of the main body into the jaw on the corresponding web side surface 38/59, with the web root 36/57, but not with the web tip, and in this manner it supports the transmission of the torque to the main body, without the possibility of damaging the web tip during the screwing in. Such an interaction/bracing/abutment between spring web root and slot edge exists in each screw-in element pair used in the insertion kit according to the invention, in order to support the transmission of the torque in rotation direction, when radial spring webs/slots are arranged between two screw-in element pairs.

For mechanical and geometric reasons, the use of three screw-in elements such as, for example, inner edge surfaces on the main body 10, is advantageous; however, it is also possible to provide two to six screw-in elements such as inner edge surfaces, on which corresponding outer edge surfaces 48 of the screw-in base engage as screw-in elements, as long as during the insertion of the screw-in base 40 the positive-locking elements on main body 10 and screw-in base 40 can reliably be made to engage. In the embodiments according to the invention, between the inner edge surfaces, in each case protrusions such as spring webs 26 can be provided in appropriate number, wherein, for reasons of improved force transmission, the spring webs and the inner edge surfaces can extend axially over the entire axial length of the positive-locking section and enable the torque transmission via the shape-complementary outer edge surfaces of the screw-in base.

The screw-in base shown in FIG. 3 comprises coronally a support collar 54, adjoined apically by an end section 52, which can comprise a circumferential slot, not represented, for the reception of a sealing means such as an O-ring, not represented, in the end section 52, a positive-locking section 46 and a guide section 44. In the positive-locking section 46, several screw-in elements each in the form of outer polygonal surfaces 48 and axially extending slots 50 are provided, each corresponding in shape, arrangement and number thereof respectively to the screw-in elements and the spring webs 26 in the positive-locking section 20 of the main body 10. In the screw-in base 40 arranged in the main body, the slots 50 are arranged with play preferably in the center relative to the spring webs 26 in the main body 10 and preferably without contact, in order to prevent damaging the spring webs 26, while the screw-in elements 30 on the main body 10 are in positive-locking and/or frictional locking engagement with the screw-in elements 48 on the screw-in base 40, in order to enable torque transmission.

During the insertion of the screw-in base 40, which is provided with an axial longitudinal bore 42, whose inner diameter corresponds approximately to the outer diameter of the retaining screw [60 in FIG. 4], not shown in FIG. 2, into the main body 10, the guide section 44 engages in the guide section 18 of the annular recess 16, wherein the cylindrical lateral surface of the guide section 44 comes in contact with the inner cylindrical lateral surface of the guide section 18 of the main body 10.

When the screw-in base is inserted, the end section 52 of the screw-in base 40 is arranged in the end section 22 of the main body 10. The spring webs 26 are positioned in the slots 50, while the support collar 54 can come in contact with the front edge 28. Thus, the screw-in base 40 is secured sealingly and via the screw-in element pairs [30; 48] with positive locking to the main body 10.

By means of the retaining screw 60, shown in FIG. 4, which passes through the screw-in base 40, and which can be screwed into the inner threading 14 of the main body 10, the screw-in base can be connected in a rotationally fixed manner to the main body 10. In order to facilitate the removal of the screw-in base 40 from the main body 10, for example, when the abutment 140 is to be inserted, it is possible to provide an inner threading in the bore 42 passing through the screw-in base 40, into which, after the removal of the retaining screw, an impression post, not represented, with outer threading can be screwed in, which is braced with the apical end thereof against the inner threading 14 of the main body. During the screwing in of the impression post, the screw-in base 40 can then be coronally lifted from the main body 10 and removed.

In the coronal end section on the support collar 54, the screw-in base 40 comprises on the inner side screw-in element 56, which can be designed as inner polygonal surfaces 56, and which can form a positive-locking connection with the outer polygonal surfaces 88 in the positive-locking section 86 on the screw-in head 80. In this way, the transmission of the torque from the angle piece via the retaining shaft 110 and the screw-in head 80 to the screw-in base 40 and the main body 10 can occur and enable the screwing of the insertion kit into the jaw. Here too, for mechanical and constructive reasons, the use of three inner edge surfaces 56 on the screw-in base 40 is advantageous; however, two to six inner edge surfaces can also be provided, on which corresponding shape-complementary outer edge surfaces 88 of the screw-in head 80 engage as screw-in elements, as long as the screw-in elements [56; 88] on the screw-in base 40 and screw-in head 80 can reliably be made to engage.

As shown in FIG. 4, the retaining screw 60 comprises an apically arranged threading 62, a middle section and a screw head 66, which has an apical lower section 68 with cone collar 64 and a coronal upper section 70. The lower section 68 has a greater radial diameter compared to the upper section 70 and, during the screwing in of the retaining screw 60 it presses the screw-in base 40 against the main body 10 by means of the cone collar 64 via the conical section 58. Between the upper section 70 and the screw-in base 40, a cylindrical slot can thus be formed radially between screw head 66 and screw-in base, into which a tubular cylindrical section 84 of the screw-in head 80 can engage, thus enabling a guiding of the screw-in head 80 in the screw-in base 40. In the tubular cylindrical section 84 of the screw-in head, locking elements can be provided, which, with appropriately corresponding locking elements on the screw-in base 40 and/or on the screw head 66 of the retaining screw 60, enable a securing of the screw-in head on the screw-in base 40 already without retaining shaft 110 or second retaining screw. In the screw head 66, an inner hexagonal section (hexagonal socket) is provided, which is additionally provided with an inner threading. By means of a hexagonal socket wrench, the retaining screw 60 can be unscrewed from the main body 10, to make possible the removal of the screw-in base 40 and the insertion of an abutment 140 into the annular recess 16 of the main body. The outer threading 112 of the retaining shaft 110 or of a second retaining screw can be screwed into the inner threading in the inner hexagonal section of the screw head 66, so that the screw-in head 80 can be fixed on the screw-in base 40.

According to FIG. 5, on the apical end, the screw-in head 80 comprises the front surface 90, which, in the installed position on the front surface, is in contact with the support collar 54 of the screw-in base 40. In the installed position, the tubular cylindrical section 84 engages between the screw head 66 and the coronal support collar 54 of the screw-in base 40, and the screw-in elements formed as outer polygonal surfaces 88 in the positive-locking section 86 form a positive-locking/frictional locking connection with the screw-in elements formed as inner polygonal surfaces 56 on the screw-in base 40. Thus, the transmission of the torque can occur from the angle piece via the retaining shaft 110 and via the polygon 92, such as a hexagon, on the screw-in head 80 to the screw-in base 40 and thus to the main body 10. Here, the polygon 92 can be enclosed by an inner polygon provided on the screw-in tool—not represented in the figures—, in the manner of a socket wrench socket, and thus enable the force transmission from the tool to the screw-in head 80.

For mechanical and geometric reasons, the use of three screw-in element pairs (56; 88) is advantageous during the force transmission from screw-in head 80 to screw-in base 40; however, two to six screw-in element pairs can also be provided, in which in each case corresponding outer edge surfaces 88 of the screw-in head 80 as screw-in elements engage on inner polygonal surfaces 56 of the screw-in base. Instead of the polygonal connection, other positive-locking connections can also be formed in principle, for example, by the formation of pins/coaxial protrusions on a component and corresponding recesses on the other component.

FIG. 6 shows, in a top view, the retaining shaft 110 with apical threading section 112, collar flange 114 in the middle section of the retaining shaft 110 as well as placement 116 for an angle piece and a tool placement 118. For example, the retaining shaft 110 can be designed in such a manner that, by means of the collar flange 114, which is provided in the middle section of the retaining shaft 110, and which is in contact with the end section of the screw-in head 80, the screw-in head 80 is retained against the screw-in base 40 or the single-piece screw-in body 98 is retained against the main body 10 with frictional locking and/or positive locking, and a positive-locking and/or frictional locking connection is formed by the screw-in head 80 with the screw-in base 40 in the area of the front surface 90 and of the support collar 54 or by the single-piece screw-in body 98 with the main body 10.

As shown in FIG. 1A, the retaining shaft 110 can also be formed in a two-piece form, wherein the lower section can be designed in the form of a second retaining screw 94, which, when screwed into the retaining screw 60, applies the screw-in head 80 with the collar flange 114 against the screw-in base.

FIG. 7 shows a closure screw 120 with threading 122 and inner hexagon 124 for the placement of a hexagonal wrench by means of which the closure screw 120 can be screwed into the threading in the inner hexagon 72 of the retaining screw 60. By means of the closure screw, the screw-in base 40 can be closed, if the implantologist intends to use two-phase healing, and the forming tissue grows over the main body.

Thus, in one design, the insertion kit according to the invention includes the main body 10, the screw-in base 40 with retaining screw 60 secured therein, the screw-in head 80 sitting on the screw-in base, as well as the retaining shaft 110, which penetrates through the screw-in head 80, and which is secured in the retaining screw 60 in the screw-in base 40 directly or via a second retaining screw.

The abutment 140 shown as an example in FIG. 8 is used via the fastening head 152 for the fastening for a fixed tooth replacement, which is not shown. The fastening head 152 can be matched here to the individual spatial situation existing at the implantation site in the jaw. and can be shaped conically, inclined and/or convexly. In use position, beneath the sealing flange 150, which can be put on the front edge 28 of the main body 10, the abutment 140 comprises, in apical direction, an end section 148, which can comprise a circumferential slot, not represented, for the reception of a sealing means, such as an O-ring, not represented, in the end section 148, apically thereto a positive-locking section 146 and a guide section 144. In the positive-locking section 146, a number of axially extending slots 142 are provided, which correspond in shape and arrangement but not necessarily in number to the spring webs 26 in the positive-locking section 20 of the main body 10. In the inserted state, the slots 142 are engaged with the spring webs 26, while the screw-in elements 30 on the main body 10 may also not be in contact, but preferably rest on the abutment 140. Preferably, at least the slot edge 143 is supported in the screw-in direction on the web root 36 of the spring web 26 on the main body 10. In this manner, it is reliably achieved that the spring webs are not sheared off due to the rotation movement. Details of the main body-abutment connection are shown in FIG. 9B.

During the insertion of the abutment 140, which is provided with an axial longitudinal bore, the inner diameter of which corresponds approximately to the outer diameter of the retaining screw not shown in FIG. 2 [60 in FIG. 4], into the main body 10, the guide section 144 engages in the guide section 18 of the annular recess 16 of the main body 10, wherein the cylindrical lateral surface of the guide section 144 comes in contact with the inner cylindrical lateral surface of the guide section 18 of the main body 10.

The end section 148 of the abutment 140 can be arranged with tight fit in the end section 22 of the main body 10. The spring webs 26 engage in the slots 142, while the sealing flange 150 comes in contact with the front edge 28. Thus, the abutment 140 is secured sealingly and with positive locking in a rotationally fixed manner to the main body 10.

By means of a retaining screw passing through the abutment 140, which can correspond to the retaining screw 60 and be screwed into the inner threading 14 of the main body 10, the abutment 140 can be connected in a rotationally fixed manner to the main body 10. In order to facilitate the removal of the abutment 140 from the main body 10, in the bore passing through the abutment, an inner threading, not represented in FIG. 8, can be provided, into which, after the removal of the retaining screw, an impression post with outer threading, which is not represented, can be screwed, which is supported by its apical end on the inner threading 14 of the main body. When the impression post is screwed in, the abutment 140 is then lifted coronally out of the main body 10 and can be removed.

The embodiment example of a main body 10 shown in FIG. 9A, which is in the insertion kit according to the invention as shown in FIG. 1, with an abutment 140 inserted into the main body and secured with retaining screw 154, in the top view as well as in the axial longitudinal section in the top view along the plane A-A, is further explained in the enlarged cross-sectional view according to FIG. 9B in the plane B-B shown in the top view on the right, as well as in the detail view in FIG. 9B.

As shown there, the positive-locking section (20) of the main body (10) and the positive-locking section (146) of the abutment (140) comprise two to six mutually shape-complementary positive-locking element pairs (26; 142) in the form of radially inward directed spring webs (26), coaxial relative to the longitudinal axis of the main body, on the main body (10) and corresponding slots (142) with slot surfaces (141) and two slot edges (143) on the abutment (140) in the manner of a tongue and groove connection, wherein the positive-locking section (20) of the main body (10) and of the positive-locking section (146) of the abutment (140) comprise two to six mutually shape-complementary inner edge-outer edge pairs in the form of inner edge surfaces on the main body (10) and corresponding outer edge surfaces on the abutment (140), which respectively are formed peripherally preferably alternatingly with the positive-locking elements in main body (10) and abutment (140). Here, the inner edge surfaces (30) on the main body (10) and the corresponding outer edge surfaces (145) on the abutment (140) come at least partially in contact during the insertion of the abutment (140) into the main body (10).

Furthermore, here, in particular, each slot edge (143) of the slots (142), which is coaxial relative to the longitudinal axis of the main body, can come in contact with the spring web root (36), which is coaxial relative to the longitudinal axis of the main body, of the corresponding spring web (26).

The web side surfaces (38) of each spring web (26) on the main body (10) and the slot surfaces (141) of the slots (142) on the abutment (140) come at least partially in contact during the insertion of the abutment (140) into the main body (10).

Thus, the invention also relates to an abutment (140) for an endosseous single-tooth implant for a fixed tooth replacement according to any one of claims 14-16, with a guide section (144), with a positive-locking section (146), with an end section (148), with a bore for receiving the retaining screw, and with a fastening head (152) for the tooth replacement,

wherein, in the positive locking section (146) of the abutment (140), two to six, in particular three, slots (142), which are coaxial relative to the longitudinal axis of the abutment, are arranged, which have slot surfaces (141) and slot edges (143), which are designed to form a tongue and groove connection with spring webs (26) on the main body (10),

wherein, in the positive-locking section (146) of the abutment (140), two to six, in particular three, outer edge surfaces (145) are arranged, which are designed for the formation of an inner edge-outer edge pair with inner edge surfaces (30) on the main body (10), and which are formed circumferentially in each case preferably alternating with the slots (142) on the abutment (140), and

wherein each slot edge (143), which is coaxial relative to the longitudinal axis of the abutment, is designed so that, in use position, the slot edge (143) comes in contact with the spring web root (36), which is coaxial relative to the longitudinal axis of the main body (10), of the corresponding spring web (26), and

wherein, during the insertion of the abutment (140) into the base body (10), the slot surfaces (141) on the abutment (140) and the corresponding web side surfaces (38) on the main body (10) come in contact at least partially,

as well as the substantially cylindrical main body (10) corresponding thereto, which can be inserted into a bore introduced into a jaw bone, with an annular recess (16) with a positive-locking section (20) and with a bore (12) arranged coaxially relative to the annular recess (16) and which comprises apically a threading (14) for the securing of a retaining screw.

### LIST OF REFERENCE NUMERALS

10 Main body

12 Bore

14 Inner threading

16 Annular recess

18 Guide section

20 Positive-locking section

22 End section

26 Web

28 Front edge

30 Screw-in element/inner polygonal surface

32 Wall

34 Chip flute

36 Web root

38 Web side surface

40 Screw-in base

42 Bore with inner threading section

44 Guide section

46 Positive-locking section

48 Screw-in element/outer polygonal surface

50 Slot

51 Slot edge

52 End section

54 Support collar

55 Spring web

56 Screw-in element/inner polygonal surface

57 Spring web root

58 Conical section (inner)

59 Spring web side surface

60 Retaining screw

62 Outer threading

64 Cone collar

66 Screw head

68 Lower section

70 Upper end section

72 Inner hexagon with inner thread

80 Screw-in head

82 Bore

84 Guide section

86 Positive-locking section

88 Screw-in element/outer polygonal surface

89 Slot edge

90 Front surface

91 Slot

92 Outer polygon such as a hexagon, for example

94 Second retaining screw

96 Annular slot

97 Scanbody marking

98 Screw-in body

100 Apical guide section

102 Positive-locking section

104 Coronal end section

105 Slot

106 Screw-in element/outer polygonal surface

107 Spring web root

108 Slot edge

109 Index marking

110 Retaining shaft

112 Outer threading

114 Collar flange

116 Angle piece placement

118 Placement

120 Closure screw

122 Threading

124 Inner hexagon

140 Abutment

141 Slot surfaces

142 Slot

143 Slot edge

144 Guide section

145 Outer polygonal surface

146 Positive-locking section

148 End section

150 Sealing flange

152 Fastening head

154 Retaining screw

1. An insertion kit for an endosseous single-tooth implant for a fixed tooth replacement, comprising:
a substantially cylindrical main body (10), configured to be insertable into a bore introduced into a jaw bone, with an annular recess (16) with a positive-locking section (20) and with a bore (12) arranged coaxially relative to the annular recess (16), and which comprises apically a threading (14) for the securing of a retaining screw;
a screw-in base (40), configured to be insertable into the annular recess (16) of the main body (10), with a positive-locking section (46), wherein the screw-in base (40) comprises a bore (42), which penetrates through the screw-in base (40) coaxially relative to the annular recess (16), for receiving a retaining screw (60);
a retaining screw (60) with an apical outer threading (62) and a coronal screw head (66), wherein the retaining screw (60) is configured to be insertable in the bore (42) of the screw-in base and screwed into the threading (14) of the main body (10);
a screw-in head (80), configured to be engageable with the screw-in base (40), and which comprises a bore (82) arranged coaxially relative to the annular recess (16) and a projection at the coronal end thereof, preferably in the form of an outer polygon (92), for a screw-in tool, and
a retaining shaft (110), configured to be insertable in the bore (82) of the screw-in head (80) and which, at one end, configured to be fixable to the retaining screw (60) and, at the other end, comprises a projection for a dental angle piece,
wherein the positive-locking section (20) of the main body (10) and the positive-locking section (46) of the screw-in base (40) comprise mutually complementary screw-in elements (30; 48) which, during the insertion of the screw-in base (40) in the main body (10), are made to engage with one another, and wherein the screw-in base (40) and the main body (10), in the engagement position of the mutually complementary screw-in elements, are secured in a rotationally fixed manner with respect to one another,
wherein the mutually complementary screw-in elements on main body (10) and screw-in base (40) are designed as respective shape-complementary screw-in element pairs comprising inner edge-outer edge, pins-recesses, or Morse taper-Morse cone pairs.

2. An insertion kit for an endosseous single-tooth dental implant for a fixed tooth replacement, comprising:
a substantially cylindrical main body (10), configured to be insertable into a bore introduced into a jaw bone, with an annular recess (16) with a positive-locking section (20) and with a bore (12) arranged coaxially relative to the annular recess (16), and which comprises apically a threading (14) for the securing of a retaining screw;
a screw-in base (40), configured to be insertable into the annular recess (16) of the main body (10), which comprises a bore (42), which penetrates through the screw-in base (40) coaxially relative to the annular recess (16), for receiving a retaining screw (60);
a retaining screw (60) with an apical outer threading (62) and a coronal screw head (66), wherein the retaining screw (60) configured to be insertable in the bore (42) of the screw-in base (40) and screwed into the threading (14) of the main body (10);
a screw-in head (80), configured to be engageable with the screw-in base (40), and which comprises a bore (82) arranged coaxially relative to the annular recess (16) and a placement at the coronal end thereof, preferably in the form of an outer polygon (92), for a screw-in tool, wherein the screw-in base (40) and the screw-in head (80) are designed as a single-piece screw-in body (98), and
a retaining shaft (100), configured to be insertable in the bore (82) of the screw-in head (80) and which, at one end, configured to be fixable to the retaining screw (60) and, at the other end, comprises a placement for a dental angle piece,
wherein the positive-locking section (20) of the main body (10) and the positive-locking section (102) of the screw-in body (98) comprise mutually complementary screw-in elements (30; 106), which, during the insertion of the screw-in body (98) in the main body (10), are made to engage with one another, and wherein the screw-in base (40) and the main body (10), in the engagement position of the mutually complementary screw-in elements, are secured in a rotationally fixed manner with respect to one another,
wherein the mutually complementary screw-in elements on main body (10) and screw-in body (98) are designed as respective shape-complementary screw-in element pairs comprising inner edge-outer edge, pins-recesses or Morse taper-Morse cone pairs.

3. An insertion kit for an endosseous single-tooth dental implant for a fixed replacement tooth according to claim 1,
wherein the annular recess of the main body includes an apical guide section, the positive-locking section arranged coronally relative to the apical guide section, and a coronal end section arranged coronally relative to the positive-locking section, and
wherein the screw-in base/the screw-in body includes an apical guide section, a positive-locking section and a coronal end section, which correspond to the corresponding sections of the main body.

4. An insertion kit for an endosseous single-tooth dental implant for a fixed tooth replacement according to claim 1, wherein, on the coronal end, the screw-in base comprises a positive-locking section with screw-in elements, which can be made to engage together with screw-in elements of the screw-in head, and the screw-in base and the screw-in head are secured in a rotationally fixed manner in engagement position of the mutually complementary screw-in elements, wherein the mutually complementary screw-in elements on screw-in base and screw-in head are designed as respective shape-complementary screw-in element pairs comprising inner edge-outer edge, pins-recesses or Morse taper-Morse cone pairs.

5. An insertion kit for an endosseous single-tooth dental implant for a fixed tooth replacement according to claim 1, wherein the screw head of the retaining screw comprises an inner polygon and preferably an inner threading arranged in the inner polygon.

6. An insertion kit for an endosseous single-tooth dental implant for a fixed tooth replacement according to claim 1, wherein the screw head of the retaining screw in the use position is sunk in the screw-in base.

7. An insertion kit for an endosseous single-tooth dental implant for a fixed tooth replacement according to claim 1, wherein the retaining screw and the retaining shaft are formed as a single piece.

8. An insertion kit for an endosseous single-tooth dental implant for a fixed tooth replacement according to claim 1, wherein the retaining shaft is formed as two pieces.

9. An insertion kit for an endosseous single-tooth dental implant for a fixed tooth replacement according to claim 1, wherein the retaining shaft is designed so that, in the use position, the retaining shaft retains main body, screw-in base and screw-in head or main body and screw-in body in engagement.

10. An insertion kit for an endosseous single-tooth dental implant for a fixed tooth replacement according to claim 1, wherein the mutually complementary screw-in elements on main body and screw-in base, the mutually complementary screw-in elements on screw-in base and screw-in head, and the mutually complementary screw-in elements on main body and screw-in body are formed as respective two to six shape-complementary screw-in element pairs comprising inner edge-outer edge, pins-recesses or Morse taper-Morse cone pairs, which are arranged preferably evenly spaced in circumferential direction.

11. An insertion kit for an endosseous single-tooth dental implant for a fixed tooth replacement according to claim 10, wherein, at least between two shape-complementary screw-in element pairs, which are selected from inner edge-outer edge and pins-recesses and Morse taper-Morse cone pairs, and which arranged adjacently in circumferential direction, a positive-locking element pair in the form of a spring web-slot connection is arranged, wherein at least the slot edge, which is coaxial relative to the longitudinal axis of the main body, of at least one slot, at least in screw-in direction, comes in contact with the coaxial spring web root, which is coaxial relative to the longitudinal axis of the main body, of the corresponding spring web.

12. An insertion kit for an endosseous single-tooth dental implant for a fixed tooth replacement according to claim 11, wherein, in each case between two adjacent screw-in element pairs, a positive locking element pair in the form of a spring web-slot connection is arranged.

13. An insertion kit for an endosseous single-tooth dental implant for a fixed tooth replacement according to claim 11, wherein the positive-locking element pair in the form of a spring web-slot connection is arranged between two adjacent screw-in element pairs, in such a manner that, when the main body is screwed into or unscrewed from the jaw, no contact occurs between the spring web and slot, and only the slot edge, which is coaxial relative to the longitudinal axis of the main body, of at least one slot, in the rotation direction, comes in contact with the spring web root, which is coaxial with respect to the longitudinal axis of the main body, of the corresponding spring web.

14. An insertion kit for an endosseous single-tooth dental implant for a fixed tooth replacement according to claim 11, wherein the positive-locking element pair in the form of a spring web-slot connection is arranged between two adjacent screw-in element pairs, in such a manner that the slot edge, which is coaxial with respect to the longitudinal axis of the main body, comes in contact on both sides with the spring web root, which is coaxial relative to the longitudinal axis of the main body (10), of the corresponding spring web, wherein, between the two contact points, spring web and slot are spaced apart with play.

15. An insertion kit for an endosseous single-tooth implant for a fixed tooth replacement according to claim 1, wherein, on the outside, on at least one of main body, screw-in base, screw-in head or screw-in body, at least one index marking, which indicates the position of at least one screw-in element and/or the position of at least one positive-locking element pair, is present, and/or on the outside, on screw-in head or screw-in body, at least one scanbody marking is present.

16. An endosseous single-tooth implant for a fixed tooth replacement, comprising:
a substantially cylindrical main body (10), configured to be insertable into a bore introduced into a jaw bone, with an annular recess (16), with a positive-locking section (20), and with a bore (12) which is open toward the coronal end thereof and arranged apically relative to the annular recess (16), and which comprises a threading section (14) arranged at the apical end in the main body for the fixation of a retaining screw, wherein the annular recess (16) includes a guide section (18), a positive-locking section (20) coronally adjoining the guide section (18), and an end section (22) coronally adjoining the positive-locking section (20),
an abutment (140), configured to be insertable into the recess (16) of the main body, with a guide section (144), with a positive-locking section (146), with an end section (148), with a bore for receiving the retaining screw, and with a fastening head (152) for the tooth replacement, and
a retaining screw (154), configured to be insertable into and passes through the bore of the abutment (140) and of the main body (10),
wherein the positive locking section (20) of the main body (10) and the positive-locking section (146) of the abutment (140) comprise two to six mutually shape-complementary positive locking element pairs (26; 142) in the form of radially inward directed spring webs (26), which are coaxial relative to the longitudinal axis of the main body, on the main body (10), and of corresponding slots (142) with slot surfaces (141) and two slot edges (143) on the abutment (140), in the manner of a tongue and groove connection, wherein the positive-locking section (20) of the main body (10) and the positive-locking section (146) of the abutment (140) comprise two to six mutually shape complementary inner edge-outer edge pairs in the form of inner edge surfaces on the main body (10) and corresponding outer edge surfaces on the abutment (140), which in each case are designed peripherally preferably alternating with the positive-locking elements in main body (10) and abutment (140),
wherein, during the insertion of the abutment (140) into the main body (10), the inner edge surfaces (30) on the main body (10) and the corresponding outer edge surfaces (145) on the abutment (140) come in contact at least partially.

17. The endosseous single-tooth implant for a fixed tooth replacement according to claim 16, wherein each slot edge, which is coaxial relative to the longitudinal axis of the main body, of the slots comes in contact with the spring edge root, which is coaxial relative to the longitudinal axis of the main body, of the corresponding spring web.

18. The endosseous single-tooth implant for a fixed tooth replacement according to claim 16, wherein, during the insertion of the abutment into the main body, the web side surfaces of each spring web on the main body and the slot surfaces of the slots on the abutment come in contact at least partially.

19. An abutment (140) for an endosseous single-tooth implant for a fixed tooth replacement according to claim 16, with a guide section (144), with a positive-locking section (146), with an end section (148), with a bore for receiving the retaining screw, and with a fastening head (152) for the tooth replacement,
wherein, in the positive locking section (146) of the abutment (140), two to six, in particular three, slots (142), which are coaxial relative to the longitudinal axis of the abutment, are arranged, which have slot surfaces (141) and slot edges (143), which are designed to form a tongue and groove connection with spring webs (26) on the main body (10),
wherein, in the positive-locking section (146) of the abutment (140), two to six, in particular three, outer edge surfaces (145) are arranged, which are designed for the formation of an inner edge-outer edge pair with inner edge surfaces (30) on the main body (10), and which are formed circumferentially in each case preferably alternating with the slots (142) on the abutment (140), and
wherein each slot edge (143), which is coaxial relative to the longitudinal axis of the abutment, is designed so that, in use position, the slot edge (143) comes in contact with the spring web root (36), which is coaxial relative to the longitudinal axis of the main body (10), of the corresponding spring web (26), and
wherein, during the insertion of the abutment (140) into the base body (10), the slot surfaces (141) on the abutment (140) and the corresponding web side surfaces (38) on the main body (10) come in contact at least partially.
